(19) United States
(12) Patent Application Publication
(10) Pub. No.: US 2010/0098355 A1
(43) Pub. Date: Apr. 22, 2010

(54) BAG HAVING A CLOSURE ASSEMBLY

(76) Inventor: MARK E. JANSEN, Appleton, WI (US)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 12/254,391

(22) Filed: Oct. 20, 2008

(51) Int. Cl. B65D 30/00; B31B 19/64; B31B 19/26; B65D 30/10; B65D 30/20; B65D 30/06; B31B 1/62

(52) U.S. Cl. 383/121; 383/123; 493/189; 493/243; 493/264

(57) ABSTRACT

A bag having a closure assembly includes a first sealing strip on an first panel of the bag, wherein the first sealing strip is pivotable by doubling over the bag to pivot the first sealing strip toward a second panel of the bag, with the end of the bag between the first sealing strip and the second panel, and the second panel having a quantity of heat activated adhesive for heat activation to adhere to the first sealing strip and to the end of the bag.

### FIELD OF THE INVENTION

The present invention relates to a bag having a closure assembly, and a method of manufacturing the bag having the closure assembly.

### BACKGROUND

U.S. Pat. No. 5,840,002 discloses a bag having gusseted side panels defined by longitudinal folds and a longitudinal center gusset fold. A scoring apparatus is disclosed to create the longitudinal folds. Diagonal fold lines create a flat end.

U.S. Pat. No. 4,273,550 discloses a scoring apparatus for folding a gusseted bag. The bag has folded corner tucks that are unfolded when the bag is expanded. A gusseted bag is used for storing bulk contents, such as, grains, cereals, pet food and seeds. After filling the bag with contents, heat sealing equipment operates to close and seal an end of the bag. A paper bag can be manufactured with a heat activated adhesive on an end of the bag. The heat sealing equipment clamps the end of the bag, and applies heat and pressure to activate the heat activated adhesive and form adhesive melt bonds, which seal the bag.

U.S. Pat. No. 4,498,192 discloses, in bag-forming operations, a first flap is folded and glued against the outer face of a front panel, and the closure is completed by folding and gluing a second flap over the open end in a manner to refold the first flap and engage the outer face of the first panel.

The trend has been to replace a paper bag with a woven bag having a polypropylene weave layer laminated to at least one layer of non-woven polypropylene film. Attempts were made to close an open end of a woven bag with a hot melt adhesive, and to use existing heat sealing equipment to apply heat and pressure to melt the adhesive and provide an adhesive melt bond that would seal the bag opening. However the high temperature required to melt the adhesive can cause the woven bag to melt and delaminate. Substituting an adhesive with a lower melt temperature was unsuccessful since the multiple layers of the bag provided insulation from the applied heat, which prevented sufficient melting of the adhesive to form strong adhesive melt bonds. Moreover, the bag would be subject to rough handling during storage and shipment, and thereby is required to pass a drop test by remaining sealed when subjected to the drop test that simulates rough handling. Further, a closure assembly is desirably combined with the bag for convenience in closing and sealing an open end of the bag with an adhesive of the closure assembly. A further feature is for the adhesive of the closure assembly to form a severable temporary bond holding the bag end flat and closed, wherein the temporary bond is severed upon opening the bag end for the purpose of filling the bag with contents, and thereafter the bag end is closed and folded over, and the adhesive is remelted to form a permanent closure and seal of the bag end that will pass a drop test.

### SUMMARY OF THE INVENTION

A bag having a closure assembly comprises, a first sealing strip assembled on an first panel of the bag, wherein a sealing flap portion of the first sealing strip projects beyond a bag opening at an end of the bag, the first sealing strip being pivotable with the end of the bag panel upon doubling over the bag to pivot the first sealing strip and the end of the bag toward a second panel of the bag, the first sealing strip being adapted with a quantity of adhesive to adhere the sealing flap portion to the second panel, and the second panel being adapted with another quantity of adhesive to adhere to the end of the bag.

According to an embodiment of the invention, the adhesive includes a heat activated adhesive applied on the portion of the first sealing strip before assembly of the first sealing strip on the first panel of the bag. According to another embodiment of the invention, the adhesive is applied on the portion of the first sealing strip after said assembly.

According to another embodiment of the invention, the first sealing strip is assembled on the first panel of the bag with a quantity of hot melt adhesive, and the heat activated adhesive has a lower melt temperature than the hot melt adhesive.

According to another embodiment of the invention, the second panel of the bag includes a second sealing strip assembled on the second panel of the bag, the first sealing strip being pivotable with the first panel upon doubling over the bag to pivot the first sealing strip toward a second panel of the bag and in alignment with the second sealing strip, with the end of the bag between the first sealing strip and the second sealing strip, and a quantity of heat activated adhesive on the second sealing strip for heat activation to adhere the second strip to the first sealing strip and to an end of the bag.

According to another embodiment of the invention, the second sealing strip is assembled on the second panel of the bag with a quantity of hot melt adhesive, and the heat activated adhesive has a lower melt temperature than the hot melt adhesive.

A method of malting a bag having a closure assembly includes, assembling a first sealing strip on an first panel of the bag, wherein the first sealing strip projects beyond an end of the bag, assembling a second sealing strip on a second panel of the bag, such that the first sealing strip is pivotable with the first panel and the second panel to pivot the first sealing strip in mutual overlapping alignment with the second sealing strip, and with the end of the bag therebetween, and applying a quantity of heat activated adhesive on the second sealing strip for heat activation to adhere the second strip to the first sealing strip and to adhere the second strip to the end of the bag.

A method of closing a bag with a closure assembly includes, assembling a first sealing strip on an first panel of the bag, wherein the first sealing strip projects beyond an end of the bag, assembling a second sealing strip on a second panel of the bag, pivoting the first sealing strip together with the first panel and the second panel to pivot the first sealing strip in mutual overlapping alignment with the second sealing strip, and with the end of the bag therebetween, and heat activating a quantity of heat activated adhesive on the second sealing strip to adhere the second strip to the first sealing strip and to adhere the second strip to the end of the bag.

### BRIEF DESCRIPTION OF THE DRAWINGS

Embodiments of the invention will now be described by way of example with reference to the accompanying drawings.

FIG. 1 is a schematic view of a laminated continuous tube to be fabricated into one or more bags.

FIG. 2 is a schematic view of a bag being fabricated from the tube disclosed by FIG. 1.

FIG. 2A is a schematic view of the bag disclosed by FIG. 2 at one stage of fabrication thereof.

FIG. 3 is a schematic view of a bag being fabricated with sealing strips.

FIG. 3A is a schematic view of the bag of FIG. 3, closed and sealed.

FIG. 4 is a schematic view of another embodiment of a bag being fabricated with sealing strips.

FIG. 4A is a schematic view of the bag of FIG. 3A, closed and sealed.

### DETAILED DESCRIPTION

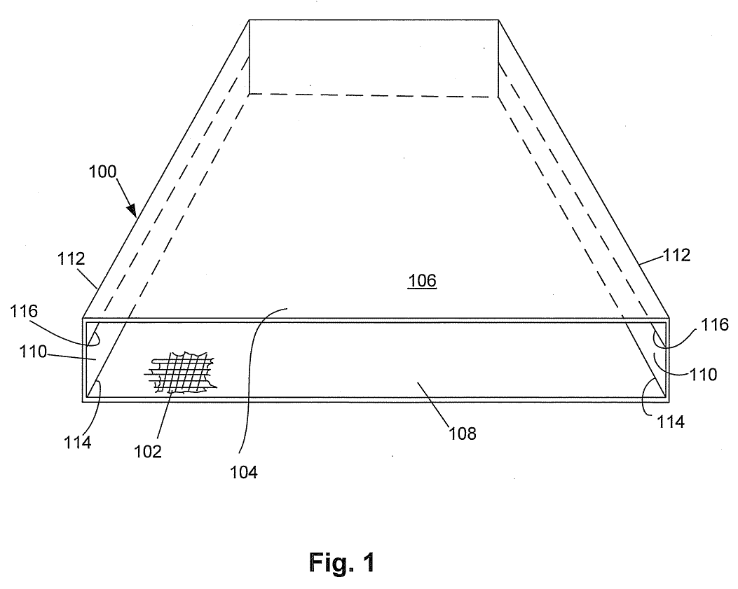

FIG. 1 discloses a laminated tube 100 to be fabricated into one or more bags. The tube 100 has a woven inner layer 102, a portion of which is illustrated to comprise a tight basket weave of thin, flexible, elongated strips of a polymeric material, for example, polypropylene. The inner layer 102 advantageously comprises a woven seamless tube that is highly flexible due to the weave. The laminated tube 100 has at least one outer layer 104 of a printable polymeric material, for example, polypropylene film that is capable of being printed with graphics using water based pigments or solvent based pigments. In an embodiment of the invention, the outer layer 104 is reverse printed on an inside surface of a first polypropylene film. A second layer of polypropylene film is laminated to the first layer, with the printed surface between the first and second layers of film. After printing the outermost layer 104, each outer layer 104 and the woven inner layer 102 are laminated, for example, by applying a solventless adhesive or solvent based adhesive between the layers to be laminated, and applying heat and pressure to laminate each outer layer 104 and the inner layer 102 and form the continuous laminated tube 100.

As disclosed in FIG. 1, the laminated continuous tube 100 further comprises a first panel 106, a second panel 108 and two gusseted side panels 110, wherein each side panel 110 joins the first panel 106 and the second panel 108 along respective longitudinal edge folds 112, 114, and wherein each side panel 110 comprises a longitudinal center gusset fold 116. The first panel 106 comprises either a front panel or a back panel.

To form the longitudinal folds 112, 114 and center gusset fold 116 as creases, a known scoring apparatus applies the creases along score lines. The creases comprise localized inelastic material strain, which provides locally increased flexibility that allows the material to flex locally along the creases and fold along the creases. Further details of a scoring apparatus are disclosed in U.S. Pat. No. 4,273,550 and U.S. Pat. No. 5,840,002.

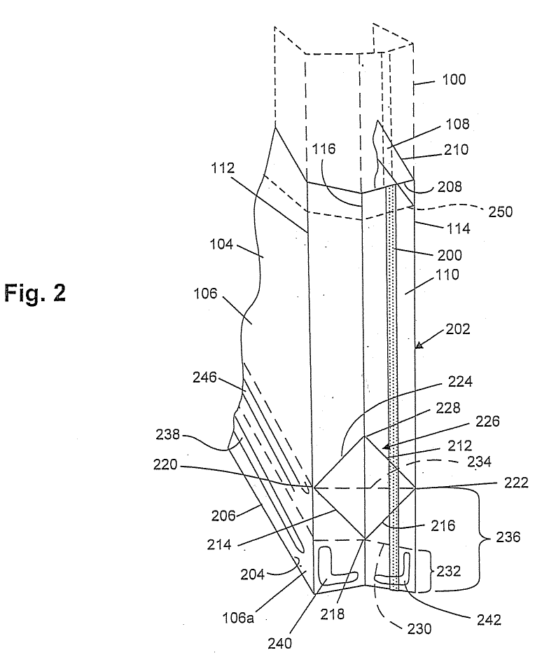

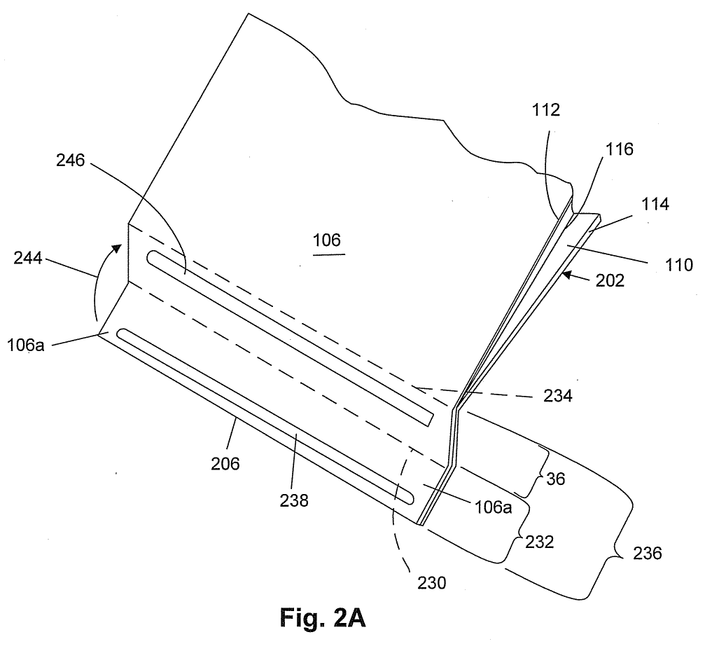

FIG. 2 discloses one of the two gusseted side panels 110, which are of duplicate construction. Accordingly, one gusseted side panel 100 will now be described in a manner to apply to each gusseted side panel 110 having the duplicate construction.

FIG. 2 discloses the outermost layer 104 comprising two sheets of polymeric laminate material that are seamed together along a corresponding seam 200 that extends continuously along a corresponding gusseted side panel 110. Similarly, the second side panel 110 of duplicate construction is provided with a corresponding seam 200 joining the same two sheets of polymeric material. Accordingly, the first panel 106 and the second panel 108 are seamless and provide a continuous surface for displaying printed graphics. Moreover, a bag while containing its contents is capable of being stacked and slid along the either panel 106, 108 without risking damage to a seam 200.

According to a preferred embodiment of the invention, the woven layer 102 is fabricated with the longitudinal folds 112, 114, 116 prior to lamination, and each outer layer 104 is fabricated with similar longitudinal folds 112, 114, 116 prior to lamination. According to another embodiment of the invention, the longitudinal folds 112, 114, 116 are fabricated after lamination of the woven layer 102 with each outer layer 104. A preferred embodiment further comprises 10×10 per inch, 850 denier, woven polypropylene fabric, 16.5 lb/rm polypropylene extrudate, 70 gauge polypropylene film, solventless adhesive compatible with polypropylene and ink.

The film layers 104 are comprised of thermoplastic synthetic resins, including but not limited to, linear low density or linear high density polyethylene, polypropylene coated with a layer of polyethylene, metallocene, electron-beam-cured film, polyester, PLA, or thermoplastic polymers to which a degradable or compostable additive is added to render the bag compostable. The film layers 104 are either printed or reverse-printed using a flexographic or other printing method.

The woven layer 102 while flattened, is conveyed continuously through a lamination apparatus with a first sheet or film layer 104, and is laminated, by the application of heat and pressure, on one side to the first sheet or film layer 104, which are then turned over and conveyed continuously through another lamination apparatus with a second sheet or film layer 104, and thereby, a second side of the woven layer 102 is laminated with the second sheet or film layer 104. An adhesive melt bond is established by the melt state surfaces of the polypropylene-to-polypropylene layers 102, 104, or by the melt state surfaces of a solventless adhesive between the layers 102, 104, or by the melt state surfaces of other polymer material (polyethylene coating material) between the layers 102, 104, which laminates the layers together. Further, the two film layers 104 are adhesively melt bonded and laminated together where they overlap along the seams 200.

FIG. 2 discloses a bag 202 being fabricated from the continuous tube 100. A first transverse cut line 204 defines the location where the continuous tube 100 is severed, and which defines the location of a first end 206 of the bag to be fabricated from the continuous tube 100. Further the continuous tube 100 has a second transverse cut line 208, which defines the location where the continuous tube 100 is to be severed, and which defines the location of a second end 210 of the bag 202 being fabricated from the continuous tube 100.

Further details of a bag flat end are described in PCT Application No. PCT/US08/67478 filed Jun. 19, 2008 designating the United States and claiming the benefit of U.S. provisional application No. 60/945,173 and claiming the benefit of U.S. provisional application No. 60/968,718. FIG. 2 discloses a tuck forming, folding geometry 212 fabricated in each gusseted side panel 110 near the end 206. The folding geometry 212 comprises a first set of intersecting diagonal fold lines 214, 216 intersecting at a first apex 218 approximately on the center gusset fold line 116 and extending diagonally to respective junctions 220, 222 with the longitudinal folded edges 112, 114. The folding geometry 212 further comprises a second set of intersecting diagonal fold lines 224, 226 intersecting at a second apex 228 approximately on the center gusset fold line 116 and extending diagonally to the respective junctions 220, 222.

FIG. 2 discloses quantities of adhesive 238, 240, 242 applied along a first region 232 located between the end 206 and a first crease 230. The beads of adhesive 238, 240, 242 are applied on the outside surface of the bag 202, as shown in FIG. 2, and are duplicated by being applied on the inside surface of the bag 202 along the first region 232 located between the end 206 and the first crease 230. The beads of adhesive 238, 240, 242 on the outside surface are mirror images of the beads of adhesive on the inside surface.

In FIG. 2A, at least the first region 232 of the bag 202 is collapsed flat, by folding along the longitudinal folds 112, 114, 116. In an alternative embodiment of the invention, the entire bag 202 is collapsed flat by folding entirely along the longitudinal folds 112, 114, 116. The locally applied beads of adhesive 238, 240, 242 hold the collapsed first region 232 in place, and at least partially seal the end 206 of the bag 202, while the remainder of the bag 202 above the first region 232 is free of adhesive to spread apart and provide an open bag. In FIGS. 2 and 2A, the beads of adhesive 240, 242 adhere to each other and hold the folded flat and collapsed side panel 110 in place, while the remainder of the bag 202 above the first region 232 is free of adhesive to spread apart and provide an open bag.

Then, in FIG. 2A, a portion 106a of the first panel 106 within the second region 236 is doubled back on itself by pivoting the first region 232 in the direction of the arrow 244. Then the first region 232 is folded along the first crease 230, thereby juxtaposing and flattening the first region 232 against the doubled back portion 106a of the first panel 106. The bead of adhesive 238 on the exterior surface of the first region 232 holds the first region 232 in place, while flatly folded against the doubled back portion 106a of the first panel 106. Another bead of adhesive 246 is provided along the first panel 106 in the second region 236, such that, the beads of adhesive 238, 246 adhere to each other and hold the flatly folded first region 232 in place. The adhesive at all locations where applied hold juxtaposed surfaces of the bag 202 together. By doubling back the portion 106a of the first panel 106, a portion 108a of the second panel 108 is wrapped around and over the doubled back portion 106a of the first panel 106.

The bag 202 is unfolded to provide a flat end along a region 236 that deploys transversely perpendicular to the first panel 106, the second panel 108 and each gusseted side panel 110, for the bag 202 to stand upright while being end supported on the flat end, or to exhibit the flat end in a vertical plane while the bag 202 is laid on one of its panels 106, 108. The bag 202 is further deployed or expanded by unfolding along the first transverse crease 234, such that a second region 236 extends as flat as possible to cover the flatly folded first region 232 and provide a flat end of the bag 202. The first panel 106, the second panel 108 and each gusseted side panel 110 extend perpendicular to the end. The bag 202 is adapted with a flat end on which the bag 202 is supported while being filled with contents through an opposite end of the bag 202. Although an embodiment of a flat end is disclosed herein, other embodiments of a flat end can be substituted for the embodiment of the flat end disclosed herein.

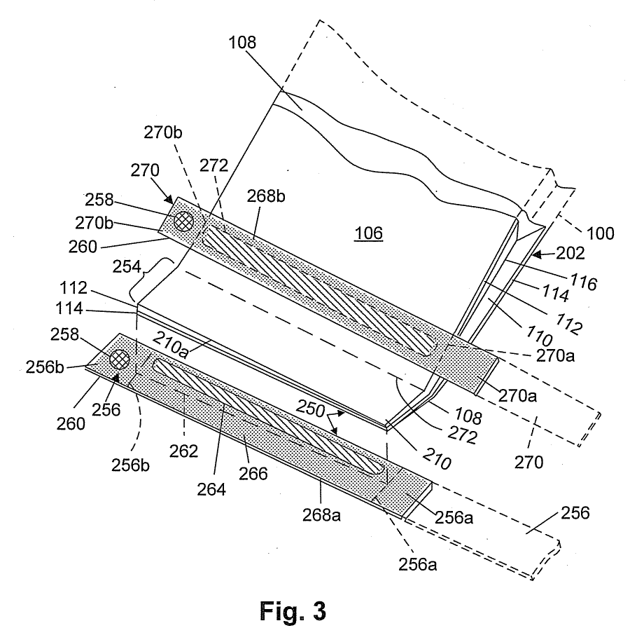

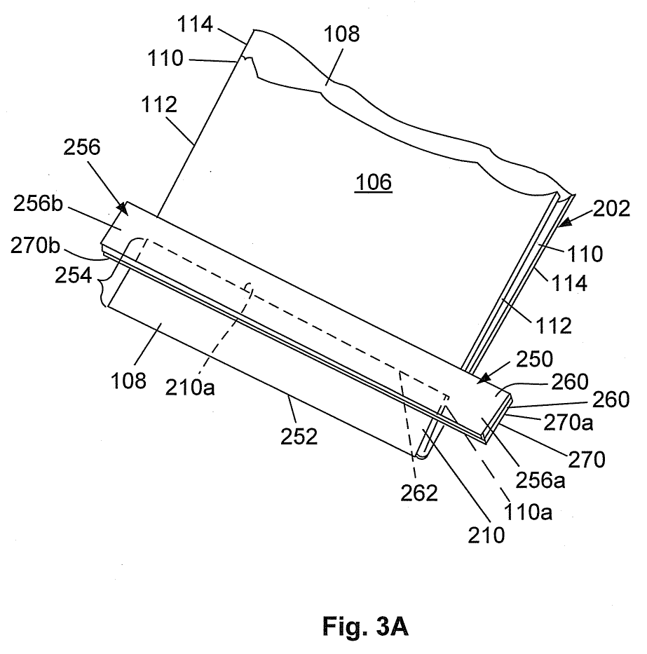

With reference to FIG. 3, an opposite end 210 of the bag 202 will now be described. While the bag 202 is flat during its manufacture, a known scoring apparatus applies a stress induced crease 252 along a score line. Further details of a scoring apparatus are disclosed in U.S. Pat. No. 4,273,550 and U.S. Pat. No. 5,840,002. The crease 252 comprises localized inelastic material strain, which provides locally increased flexibility that allows the material to flex locally along the crease 252 and form a folded region 254 at the end 210 of the bag 202.

FIG. 3 discloses an embodiment of an end closure assembly 250 for closing and sealing the end 210 of the bag 202. The end closure assembly 250 includes a first sealing strip 256 and a second sealing strip 270, which are respectively assembled to the bag 202 using corresponding first adhesives 264, 272. The first sealing strip 256 has a first longitudinal portion 262, which is placed to overlap the panel 108 adjacent to the bag end 210. The sealing strips 256, 270 are permanently bonded to the bag 202 using the first adhesives 264, 272.

The first adhesives 264, 272 are selected for an affinity to form a permanent adhesive bond to the material of the sealing strips 256, 270 and to the material of the bag 202, for example, a polyolefin including, but not limited to compostable polypropylene. According to alternative embodiments of the invention, the first adhesives 264, 272 are applied onto the bag 202 while the bag 202 is folded flat during manufacture, or the first adhesives 264, 272 are applied onto the sealing strips 256, 270.

According to one embodiment of the invention, the sealing strips 256, 270 can comprise adhesive tapes having second adhesives 268a, 268b pre-applied thereon. According to another embodiment of the invention, the sealing strips 256, 270 comprise a selected material, including but not limited to the same material as the bag 202 for compatible appearance with the bag 202. The second adhesives 268a, 268b are applied onto the sealing strips 256, 270 comprised of a selected material. A heat activated adhesive 268a is applied on the sealing flap portion 266 and on the sealing tabs 256a, 256b of the embodiment of FIG. 3A. For example, an applicator of the adhesive 268a comprises a wheel or roller that rolls over the surface of the sealing flap 266 to apply a stripe of evenly distributed, heat activated adhesive 268a. Similarly, an applicator of the adhesive 268b comprises a wheel or roller that rolls over the surface of the second sealing strip 270 to apply a stripe of evenly distributed, heat activated adhesive 268b.

With reference to FIG. 3A, during manufacture of the bag 202, the bag 202 is doubled over and folded flatly along the crease 252. The sealing strips 256, 270 are brought into alignment overlapping each other in FIG. 3A. The second adhesives 268a, 268b are selected for having an affinity for adhering to the material of the sealing strips 256, 270. Further, the second adhesives 268a, 268b are selected for heat activation to an adhesive state upon the application of heat and pressure. The second adhesives 268a, 268b are heat activated to an adhesive state, by which the sealing strips 256, 270 adhere to each other, as depicted in FIG. 3A. The second adhesives 268a, 268b are heated with a moderate amount of heat transfer thereto, and, if necessary, a moderate amount of pressure, such that the adhesives become tacky or undergo a minimized melting at the surface, by which to form a severable, temporary bond of the second adhesives 268a, 268b to each other, which joins the sealing strips 256, 270 to each other, to hold the bag end 210 flat and to hold the bag opening 210a closed. The bag end 210 is folded flat, in FIG. 3A, and the bag 202 is flat for shipment to a manufacturing location where the bag 210 is opened and filled with contents.

The bag end 210 is opened for the purpose of filling the bag 202 with contents. For example, the contents include, but are not limited to grain, cereals, bird seed or animal feed. The bag end 210 is opened by delaminating the second adhesives 268a, 268b from each other. Accordingly the second adhesives 268a, 268b are capable of forming severable, temporary bonds with each other by the application of moderate heat and pressure during manufacture of the bag 202. Further, in preparation for filling the bag 202 with contents, the bag end 210 is unfolded along the crease 252, and the bag opening 210a is opened to receive the contents.

After filling the bag 202 with contents, the bag 202 is doubled over and folded along the crease 252, and the sealing strips 252, 270 are overlapped and are permanently bonded to each other by applying heat and or pressure to re-activate the second adhesives 268a, 268b. The second adhesives 268a, 268b are capable of forming permanent melt bonds with each other. Sufficient heat and pressure are applied with standard heat sealing equipment, for the second adhesives 268a, 268b to melt and form permanent bonds when heated, melted and cooled to ambient. The sealing strips 252, 260 close and seal the bag opening 210a, and further, retain the folded region 254 doubled over and folded along the crease 252. During rough handling of the filled bag 202, the crease 252 and the folded region 254 tend to isolate the closure assembly 250 from forced opening. Thereby, the filled bag 202 and closure assembly 250 can pass a drop test.

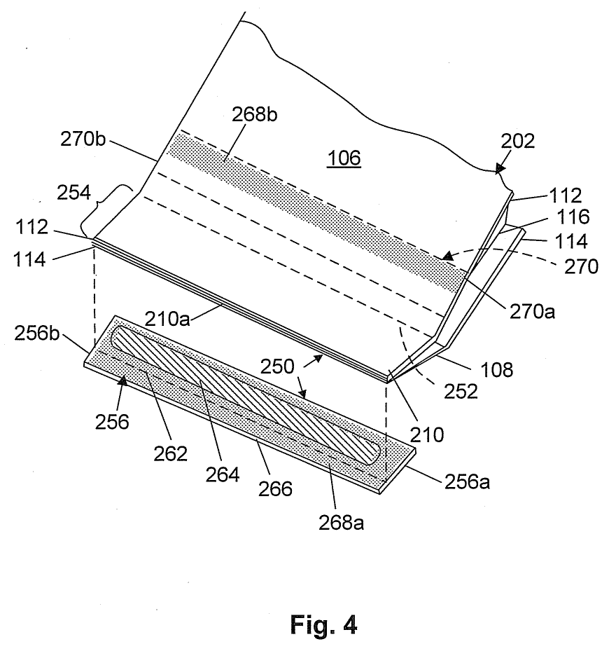

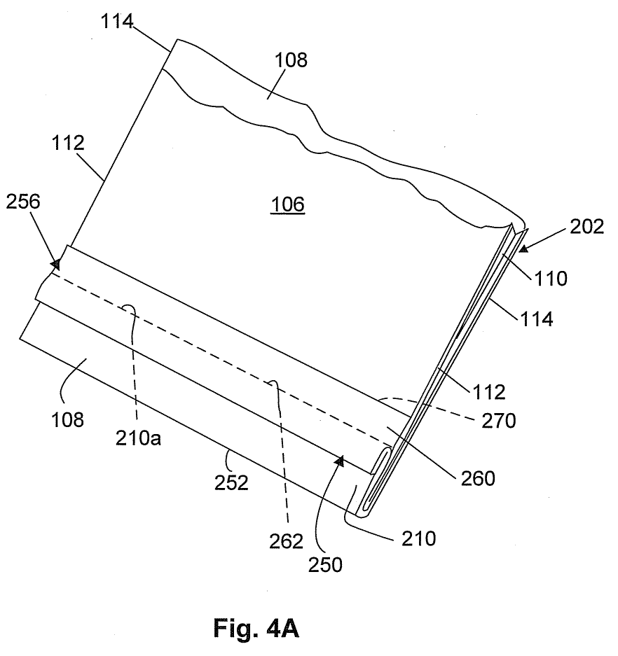

In FIGS. 3 and 4, embodiments of a first sealing strip 256 of the closure assembly 250 include a flexible lamination of a polymeric film 260 and a woven layer 258, a portion of which is shown. Both layers 258, 260 are visually compatible with matching polymer material layers of the bag 202. Both layers 258, 260 comprise compostable polypropylene, for example. The sealing strip 256 is assembled to the panel 108 of the bag 202 to extend transversely of the bag 202 and lengthwise of an elongated bag opening 210a at the bag end 210. The first sealing strip 256 has a first longitudinal portion 262, which is placed to overlap the panel 108 adjacent to the bag end 210, and which is assembled to the bag 202 with a hot melt adhesive 264. For example, a hot melt adhesive 264 is applied with an industrial applicator to the surface of the first longitudinal section 262 or to the surface of the panel 108 to be overlapped by the first longitudinal section 262, or to both said surfaces, to adhere the surfaces together. For example, the applicator comprises either a hot glue gun or a wheel or roller that rolls over the surface of the longitudinal section 262 to apply a stripe of evenly distributed, hot melt adhesive 264. Auxiliary heat and/or pressure can be applied to assure a permanent bond.

In FIG. 3, a longitudinal portion of the first sealing strip 256 projects beyond the bag end 210, as well as, beyond the elongated bag opening 210a, to provide a sealing flap 266. According to an embodiment of the invention, ends 256a, 256b of the first sealing strip 256 extend beyond the longitudinal fold lines 114, 114 at the gusseted sides 110 of the rear panel 108 to provide a first set of sealing tabs.

In FIG. 3, to eliminate the sealing tabs, the ends 256a, 256b of the first sealing strip 256 are at or near the fold lines 114, 114 as depicted by dotted lines. In FIG. 4, an alternative embodiment of the first sealing strip 256 is without sealing tabs, and has the ends 256a, 256b at or near the fold lines 114, 114.

In FIGS. 3 and 4, a portion of the panel 106 includes a second sealing strip 270 of the closure assembly 250. An exemplary embodiment of the second sealing strip 270 is a laminate similar to the first sealing strip 258, and has a woven layer 258 laminated to a polymeric film layer 260. Alternatively, the second sealing strip 270 can be eliminated as a separate piece, and a portion of the panel 106 of the bag 202 itself provides the second sealing strip 270.

According to an embodiment of the invention, the second sealing strip 270 is a separate piece, which is assembled to the panel 106 to become a portion of the panel 106. In another embodiment of the invention, the first sealing strip 256 is comprised of the same polymer material layers as the first sealing strip 256. Another exemplary embodiment of the second sealing strip 270 is an adhesive backed, paper tape similar to the first sealing strip 258.

In FIGS. 3 and 4, when the second sealing strip 270 is in the form of a laminate of a woven layer 258 laminated to a polymeric film layer 260, the second sealing strip 270 is assembled to the bag 202 with a hot melt adhesive 272. For example, a hot melt adhesive 272 is applied with an industrial applicator to a surface of a longitudinal section of the second sealing strip 270 or to a surface of a corresponding portion of the panel 106 that is overlapped by the second sealing strip 270, or both said surfaces of the sealing strip 270 and the panel 106 to adhere said surfaces together.

In FIGS. 3 and 4, alternative embodiments of a first sealing strip 256 and second sealing strip 270 of the closure assembly 250 are made from strips of a flexible, adhesive backed, paper tape. Pressure activated, or pressure sensitive, adhesives 264, 272 on the adhesive backed, paper tape are selected for an affinity to permanently bond to the polymer material layers of the bag 202, for example compostable polypropylene material content or other polyolefin material content.

In FIGS. 3 and 4, when the second sealing strip 270 is in the form of an adhesive backed, paper tape, the pressure activated adhesive 272 of the paper tape adheres the sealing strip 270 to a corresponding portion of the panel 106.

In FIG. 3, ends 270a, 270b of the second sealing strip 270 provide a second set of sealing tabs. The sealing tabs extend beyond the longitudinal fold lines 112, 112 at the sides of the panel 106. Alternatively, the sealing tabs are eliminated when the ends 270a, 270b of the second sealing strip 270 extend at or near the fold lines 112, 112 as depicted by dotted lines.

In FIGS. 3 and 4, a heat activated adhesive 268 is applied as a stripe, that is deposited by a surface of a wheel applicator onto a lengthwise section of the woven layer 258 of the second sealing strip 270. Another stripe of the heat activated adhesive 268a is similarly applied on the sealing flap portion 266 and the sealing tabs 256a, 256b of the first sealing strip 256. For example, the heat activated adhesive 268, 268a is applied as a solution that dries to be present as a solidified coating that is capable of being heat activated to an adhesive state.

During a manufacturing process, the sealing strips 270, 256 can comprise continuous lengths of tape, as shown by the dotted lines 270, 256. The sealing strips 270, 256 are cut to their desired lengths from the continuous lengths of tape. The heat activated adhesive 268, 268a is present on the continuous lengths of tape prior to cutting the strips 270, 256, or alternatively, is applied to the strips 270 and 256 after cutting from the continuous lengths of tape. The strips 270, 256 are then assembled to respective bag panels 106, 108 by the hot melt adhesives 272, 264.

In FIGS. 3A and 4A, after the sealing strips 256, 270 are assembled to the bag 202, the bag 202 is folded flat with the gusseted sides 110, 110 tucked inward, for shipment to a manufacturing location where the bag 202 is filled with contents. Similarly, in FIG. 3A the bag 202 is folded flat with the gusseted sides 110, 110 tucked inward, for shipment.

With reference to FIG. 3 the end closure assembly 250 is provided on the bag 202 to close and seal the bag end 210 as disclosed by FIG. 4. First, in FIG. 3, the bag end 210 is closed to fold inwardly the gusseted sides 110, 110, and to close together the panels 106, 106, which closes the elongated opening 210a. The first panel 106 and the second panel 108 are foldable along the crease 252 to double over the bag 202 and pivot the first sealing strip 256 toward the second panel 108 of the bag 202. In FIG. 4, the first sealing strip 106 is pivoted into overlapping alignment with the second sealing strip 270, and with the end 210 of the bag 202 therebetween. Further, the portion of the first sealing strip 106 that provides the sealing flap 266 overlaps the second sealing strip 270. Further, the panel 106 is doubled back on itself, such that the sealing strip 270 overlaps against the end 210 of the bag 202.

In FIG. 3A, the sealing strips 256, 270 are adapted to melt bond to each other. While the sealing strips 256, 270 are aligned with each other, the folded region 254 of the bag 202 is doubled back and clamping pressure is applied. Heat and pressure is applied to melt the adhesive 268a and/or the adhesive 268b on the respective sealing strips 256, 270. The melted adhesive 268a, 268b cools to ambient temperature, and forms adhesive melt bonds as the adhesive cools below its melt temperatures.

Each of the adhesives 268a, 268b has a melt temperature lower than the melt temperatures of the hot melt adhesives 264, 272, which avoids melting of the hot melt adhesives 264, 272 and avoids consequent delamination of the sealing strips 256, 270 from the bag 202. Each of the second adhesives 268a, 268b joining to each other has a melt temperature lower than the melt temperatures of the bag laminates 102, 104, which avoids melting and/or delamination of the bag laminates 102, 104.

Further, the heat is applied directly to the overlapped sealing strips 256, 270, with the end 210 of the bag therebetween, which applies the heat directly where needed, and which further avoids the application of heat elsewhere on the bag 202 to avoid delamination of the bag laminates 102, 104. Moreover, each of the heat activated adhesives 268a, 268b has a lower melting temperature than that of the bag laminates 102, 104, which avoids delamination of the bag laminates 102, 104. An embodiment of the heat activated adhesives 268a, 268b includes, but is not limited to a polyethylene based resin, e.g., polyethylene ethyl methyl acrylate (PE-EMA), and has a seal-initiation temperature of 180-220 degrees Fahrenheit. An embodiment of the hot melt adhesives 264, 272 includes, but is not limited to a polyolefin or polyamide plastomer based solventless adhesive having a softening temperature of about 300 degrees Fahrenheit. An embodiment of the bag laminates 102, 104 are polypropylene having a melt temperature of about 300-330 degrees Fahrenheit.

In FIG. 3A, the heat activated adhesive 268a on the sealing flap portion 266 adhesively melt bonds to the heat activated adhesive 268 on the sealing strip 270 which serves as an adhesive seal of the elongated opening 210a. The adhesive 268a on the woven layer 258 of the sealing strip 270 overlaps the doubled back panel 106 along the end 210 and has an affinity to form an adhesive melt bond therewith. The woven layers 258, 258 of the sealing tabs 256a, 270a, when present, adhesively melt bond to each other, to seal a portion 110a of a gusseted side 110. Similarly, the woven layers 258, 258 of the sealing tabs 256b, 270b, when present, adhesively melt bond to each other to seal a portion 110a, FIG. 4, of a gusseted side panel 110. The nonwoven film layers 260 are in view on the exterior of the closure assembly 250.

With reference to FIG. 3A, the sealing strips 256, 270 are adapted to adhesively melt bond to each other. While the sealing strips 256, 270 are aligned with each other, the folded region 254 of the bag 202 is doubled back and clamping pressure is applied. Heat and/or pressure are applied to melt the adhesive 268a, 268b on the sealing strips 256, 270. The adhesive 268a, 268b cools to ambient temperature, and forms adhesive melt bonds as the adhesive cools below its melt temperatures. The adhesives 268a, 268b have melt temperatures lower than the melt temperatures of the hot melt adhesives 264, 272, which avoids melting of the adhesives 264, 272 and avoids consequent delamination of the sealing strips 256, 270 from the bag 202. The adhesives 268a, 268b have melt temperatures lower than the melt temperatures of the bag laminates 102, 104, which avoids delamination of the bag laminates 102, 104. Further, the heat is applied directly to the overlapped sealing strips 256, 270, with the end 210 of the bag therebetween, which further avoids the application of heat elsewhere on the bag 202, and which avoids delamination of the seam 200 of the bag laminates 102, 104. Moreover, the heat activated adhesive 268a, 268 has a lower melting temperature than that of the bag laminates 102, 104, which avoids delamination of the bag laminates 102, 104.

In FIG. 4A, according to an alternative embodiment of the invention, the heat activated adhesive 268a of the first sealing strip 256 adhesively melt bonds the woven layer 258 of the sealing flap portion 266 to the portion of the panel 106 that provides the sealing strip 270, which seals the elongated opening 210a. Further, the heat activated adhesive 268b on the portion of the panel 106 adhesively melt bonds to the adhesive 268a of the first sealing strip 256 to seal the elongated opening 210a.

According to another embodiment of the invention, the first sealing strip 256 and the second sealing strip 270 are each made of a flexible paper monolayer or polymer film monolayer, or a laminate of paper on paper, or paper on polymer film, or multiple polymer films, any of which is made compostable by including a compostable filler material as a material constituent. A suitable embodiment of each of the first sealing strip 256 and the second sealing strip 270 includes a paper tape. A pressure activated adhesive 264 on the tape includes, but is not limited to a polyacrylate adhesive. In FIGS. 3 and 3A, the adhesive 264 is a quantity of a pressure activated, or pressure sensitive, adhesive on a lengthwise section of the paper, sealing strip 256, and on the sealing flap portion 266 and on the sealing tabs 256a, 256b when such tabs are present. The lengthwise section of the paper, second sealing strip 270 has a quantity of pressure activated, or pressure sensitive, adhesive 272. The quantities of pressure sensitive adhesive 256, 272 have a bonding affinity to the paper content of the paper tape. For example, a pressure sensitive adhesive 256, 270 is selected for bonding affinity to paper, and not necessarily for bonding affinity to a resin material of the bag end 210 including, but not limited to compostable polypropylene or other polyolefin content of the bag 202. Further, the pressure sensitive adhesive 256, 272 is selected for serving as an adhesive sealant to seal the bag end 210, by sealably adhering the adhesive 256 on the sealing flap 266 to overlap and adhere to the adhesive 272 on the second sealing strip 270. Further, the pressure sensitive adhesive 256, 272 is selected for a capability to be peeled apart to open the bag end 210a for filling the bag 210 with contents, and for a capability for re-adherence to seal the bag end 210a after filling the bag with contents.

While the paper sealing strips 256, 270 are aligned with each other and overlapped, the folded region 254 of the bag 202 is doubled back and clamping pressure is applied. Further, the pressure is applied directly to the overlapped sealing strips 256, 270, with the end 210 of the bag therebetween, which further avoids the application of pressure elsewhere on the bag 202.

In FIG. 4A, the adhesive 268b, FIG. 3, on the portion of the panel 106 that serves as the second sealing strip 270, adhesively bonds to the adhesive 268a on the sealing flap 266 of the first sealing strip 256 to seal the elongated opening 210a of the bag 202. The first sealing strip 256 adhesively holds the sealing flap 266 against the portion of the panel 106 that provides the sealing strip 270, which seals the elongated opening 210a. The various embodiments of the sealing strips 256, 270 can be applied to any end of the bag 202, including the opposite end 206 of the bag 202.

To prepare the bag 202 for filling with contents, the bag end 210a is re-opened by peeling apart the adhesives 268a and 268b. The opposite end 206 of the bag 202 is unfolded to provide a flat end 232. The bag 202 is supported on the flat end 232 while being filled with contents through the opening 210a at the bag end 210. After a process of filling the bag is completed, the bag end 210 will project above and beyond the contents in the filled bag 202. Thus, after filling the bag 202 with contents, the bag end 210 is available to be closed and sealed with the end closure assembly 250. In the embodiment of FIG. 3A, heat and pressure is applied to the heat activated adhesive 268a, 268b on the overlapped sealing strips 256, 270 to re-seal the elongated opening 210a. In the embodiment of FIG. 4A, pressure is applied to the pressure sensitive adhesive 268a, 268b on the overlapped sealing strips 256, 270, such that the pressure activated adhesive 268b adhesively bonds to the adhesive 268a on the sealing flap 266 of the first sealing strip 256 to seal the elongated opening 210a.

In FIG. 4, an embodiment of an end closure assembly 250 for the bag 202 includes adhesive-backed paper tape providing the first sealing strip 256 and the second sealing strip 270. During a manufacturing process, each of the sealing strips 270, 256 is cut to a desired length from a continuous length of tape. The paper tape has an adhesive 264, 272 that is pressure sensitive, i.e., activated by pressure, to assemble the tape to the bag 202. Further, the adhesive 264, 272 has an affinity for adhering to the polypropylene material (a polyolefin material) of the bag 202. After assembling the sealing strips 256, 270 to the bag 202, the first sealing strip 256 is doubled over on itself to cover the sealing flap 266 with paper side of the tape. A quantity of a heat activated adhesive 268 is applied as a stripe, that is deposited by a surface of a wheel applicator onto a lengthwise section of the paper of the second sealing strip 270. Another quantity of the heat activated adhesive 268a is similarly applied on the sealing flap portion 266 of the first sealing strip 256. The heat activated adhesive 268, 268a is present in solidified form prior to being heated to activate the adhesive property. The heat activated adhesive 268, 268a includes, but is not limited to a heat activated adhesive in solution with a solvent that is dried, and which requires heat activation to attain an adhesive state.

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Patents and patent applications referred to herein are hereby incorporated by reference in their entireties. Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A bag having a closure assembly, comprising:
a first sealing strip assembled on an first panel of the bag, wherein a portion of the first sealing strip provides a sealing flap projecting beyond a bag opening at an end of the bag, the first sealing strip being pivotable with the first panel by doubling over the bag to pivot the first sealing strip in alignment with a second panel of the bag, with the end of the bag between the first sealing strip and the second panel;
a quantity of adhesive applied to the portion of the first sealing strip to adhere the sealing flap to the second panel; and
a quantity of heat activated adhesive on the second panel for heat activation to adhere to the first sealing strip and to the end of the bag.

2. The bag of claim 1 wherein the first sealing strip is assembled on the first panel of the bag with a quantity of hot melt adhesive, and the heat activated adhesive has a lower melt temperature than the hot melt adhesive.

3. The bag of claim 2 wherein the first sealing strip has a woven layer, the woven layer is assembled on the first panel of the bag with the quantity of hot melt adhesive.

4. The bag of claim 1 comprising:
the second panel includes a second sealing strip assembled on the bag with a quantity of hot melt adhesive, wherein the heat activated adhesive has a lower melt temperature than the hot melt adhesive.

5. The bag of claim 4 wherein the second sealing strip has a film layer, the film layer is assembled on the second panel of the bag with the quantity of hot melt adhesive.

6. The bag of claim 4, comprising:
the first sealing strip includes first sealing tabs; and
the second sealing strip includes second sealing tabs, wherein the second tabs have the heat activated adhesive thereon.

7. The bag of claim 4 comprising:
a sealing flap of the first sealing strip projects beyond an end of the bag; and
a further quantity of heat activated adhesive is on the sealing flap and on the first sealing tabs.

8. The bag of claim 4 wherein the bag has respective sides, the first sealing tabs are foldable inwardly toward respective sides of the bag, and the second sealing tabs are foldable together with the first sealing tabs.

9. The bag of claim 1 wherein a sealing flap of the first sealing strip projects beyond an end of the bag for the quantity of heat activated adhesive to adhere the second strip to the sealing flap.

10. The bag of claim 1 wherein the bag is doubled over along a crease.

11. A method of malting a bag having a closure assembly, comprising:
assembling a first sealing strip on an first panel of the bag; and
positioning a quantity of heat activated adhesive on a second panel of the bag, such that the first sealing strip is pivotable upon doubling over the bag to position the first sealing strip and the end of the bag against the heat activated adhesive on the second panel in preparation for adhering the adhesive to the first sealing strip and to the end of the bag.

12. The method of claim 11, comprising:
assembling the first sealing strip on the first panel with a quantity of hot melt adhesive, wherein the heat activated adhesive has a lower melt temperature than the hot melt adhesive.

13. The method of claim 12, comprising:
assembling a woven layer of the first sealing strip on the first panel of the bag with the hot melt adhesive.

14. The method of claim 12, wherein the second panel of the bag includes a second sealing strip, and the heat activated adhesive is on the second sealing strip.

15. The method of claim 14, comprising:
assembling a film layer of the second sealing strip on the second panel of the bag with a quantity of hot melt adhesive, wherein the heat activated adhesive has a lower melt temperature than the hot melt adhesive.

16. The method of claim 12, comprising:
first sealing tabs on the first sealing strip;
second sealing tabs on the second sealing strip; and
applying the heat activated adhesive on the second sealing tabs.

17. The method of claim 16, comprising:
projecting a sealing flap of the first sealing strip beyond an end of the bag; and
applying a further quantity of heat activated adhesive on the sealing flap and on the first sealing tabs.

18. The method of claim 12, comprising:
projecting a sealing flap of the first sealing strip beyond an end of the bag for the quantity of heat activated adhesive to adhere the second strip to the sealing flap.

19. A method of closing a bag with a closure assembly, comprising:
assembling a first sealing strip on an first panel of the bag, wherein the first sealing strip projects beyond an end of the bag;
assembling a second sealing strip on a second panel of the bag;
pivoting the first sealing strip together with the first panel and the second panel to pivot the first sealing strip in mutual overlapping alignment with the second sealing strip, and with the end of the bag therebetween; and
heat activating a quantity of heat activated adhesive on the second sealing strip to adhere the second strip to the first sealing strip and to adhere the second strip to the end of the bag.

20. The method of claim 19, comprising:
the first sealing strip includes first sealing tabs; and
the second sealing strip includes second sealing tabs, wherein heat activating the quantity of heat activated adhesive on the second sealing strip adheres the second sealing tabs to the first sealing tabs.

21. A bag having a closure assembly, comprising:
a first sealing strip assembled on an first panel of the bag;
a second sealing strip on a second panel of the bag;
the first sealing strip being pivotable by doubling over the bag to pivot the first sealing strip in alignment with the second sealing strip, with the end of the bag between the first sealing strip and the second sealing strip; and
a quantity of adhesive on the second sealing strip having an affinity to adhere to the material of the first sealing strip and to the material of the end of the bag.
